(19) United States
(12) Patent Application Publication
(10) Pub. No.: US 2026/0179621 A1
(43) Pub. Date: Jun. 25, 2026

(54) AUDIO AUTHENTICATION HARDWARE KEY AND DETECTION ECOSYSTEM AND MIXED REALITY ARTIFICIAL INTELLIGENCE TRIP PLANNER

(71) Applicant: Meta Platforms, Inc., Menlo Park, CA (US)

(72) Inventors: Brian Shin-Hua Ellis, Brooklyn, NY (US); Kevin Connor, Seattle, WA (US); Alice Rakotoarison - Coleman, Long Beach, CA (US); Jeffrey Witthuhn, Lynnwood, WA (US); Panya Inversin, Los Angeles, CA (US); Dhwaj Agrawal, Redwood City, CA (US); Yoav Goldstein, Menlo Park, CA (US); Winston Esposito, San Francisco, CA (US); Vladimir Fedotov, Vancouver, WA (US); Alexander Peter Dawson, Ottawa (CA)

(21) Appl. No.: 19/431,835

(22) Filed: Dec. 23, 2025

Related U.S. Application Data
(60) Provisional application No. 63/738,709, filed on Dec. 24, 2024.
(60) Provisional application No. 63/740,133, filed on Dec. 30, 2024.

(51) Int. Cl. G10L 17/24; G06Q 50/14; G06T 19/00; G10L 15/22; G10L 15/25

(52) U.S. Cl. CPC G10L 17/24; G06Q 50/14; G06T 19/006; G10L 15/22; G10L 15/25; G10L 2015/223

(57) ABSTRACT

Methods, apparatuses, and computer program products for the authentication of human speech through the registration and verification of public and private keys associated with audio. This audio authentication hardware key and detection ecosystem may enable casual users and public figures alike to provide a positive verification that a person is who they say they are and endorse their speech. The audio code underlaying the human speech gets encoded with identifiers that effectively watermark the audio code to make it recognizable to a server and the human speech verifiable. To display this verification at a system-level within a social media platform, news channel, podcast library, or video site will combat the dangers of deepfake audio at the source—the publication of the audio/videos themselves—and prevent the spread of misinformation.

### CROSS-REFERENCE TO RELATED APPLICATIONS

This application claims priority to U.S. Provisional Application No. 63/738,709, filed Dec. 24, 2024, entitled “Audio Authentication Hardware Key And Detection Ecosystem,” and U.S. Provisional Application No. 63/740,133, filed Dec. 30, 2024, entitled “Mixed Reality Artificial Intelligence Trip Planner,” which are incorporated by reference herein in their entireties.

### TECHNOLOGICAL FIELD

The present invention relates generally to audio authentication and more particularly to the methods, apparatuses, and computer program products for the registration and verification of human speech.

### BACKGROUND

Artificial intelligence is being weaponized to create and spread misinformation across the Internet. Of the ways to spread misinformation, one of the more popular types is deepfake audio, also known as voice cloning. Deepfake audio is a type of artificial intelligence that creates realistic imitations of a human voice and can be used maliciously to trick people into believing that celebrities or politicians said things they did not say, spread false information, and gain access to personal accounts. Detecting deepfake audio is becoming increasingly difficult with the ease at which it can be created, the quality of sound and sometimes associated video, etc.

### BRIEF SUMMARY

Misinformation may be spread based on manipulated media. The disclosed subject matter provides methods, apparatuses, and computer program products for the authentication of human speech through the registration and verification of public and private keys associated with audio. In various examples, a wearable hardware device may play an audio code that underlays the human audio. This audio code may contain a unique identifier, a timestamp, a transcript of the recorded audio, and a checksum. This audio code may be received by a recognition system that may identify the code signal and decrypt the metadata to verify the legitimacy of the audio code alongside the information registered to the hardware device. Upon the verification of the audio code, such that the public key assigned to the audio code pairs correctly with the private key associated to the wearable hardware device and the transcript provided by the hardware device matches the recorded audio, a media player may display verification credentials. Upon a finding of any misalignment in the metadata, a media player may return a catered error message.

In one aspect, a method may include, at the detection of a vibration or sound that signals human speech, outputting an audible audio code at the vibrating of facial features; encoding the audio code with a series of identifiers; encrypting identifiers; and sending the audio code and associated metadata to the server.

In another aspect, a method may include receiving, at a server, an audio code to be identified; decrypting the locked metadata to recognize the code signal and verify the legitimacy of the audio code; comparing the public key associated with the audio code to the private key associated with the hardware device to determine where the audio code originated; and comparing the transcript encoded with the audio code with the recorded audio.

In another aspect, a media player may receive from the server the outputs of the recognition system and registration system and may present the resulting audio verification credentials or a catered error message. For example, if the public key assigned to the audio code matches the private key associated to the hardware device and the transcript provided by the hardware device matches the recorded audio, the media player may display a verified flag and the name of the registered voice. If the public key exists but does not match the private key, or the transcripts do not match, then the media player may display that a deepfake may have been detected. If there is no audio code, then the media player may display that no verification could be found.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 illustrates an exemplary head-mounted display.

FIG. 2A is an example method for how the head-mounted display, server, and media player may be communicatively connected with each other.

FIG. 2B is an example block diagram of the server.

FIG. 3A illustrates an example method for how the wearable hardware device records and prepares the audio code.

FIG. 3B illustrates an example method for how the server (the recognition system and the registration system) verify the legitimacy of the audio code.

FIG. 3C illustrates an example method for how the media player receives the outputs from the server and displays the appropriate assessment of the analysis from the server.

FIG. 4 illustrates an exemplary block diagram of a device.

FIG. 5 illustrates an example trip planning model.

FIG. 6 illustrates an example model architecture for the disclosed method to generate an itinerary.

FIG. 7 illustrates an example method for generating an itinerary as disclosed herein.

FIG. 8 illustrates an example trip reflection model.

FIG. 9 illustrates an example model architecture for the disclosed method for generating a trip reflection.

FIG. 10 illustrates an example method for providing travel guidance and generating a trip reflection as disclosed herein.

FIG. 11 illustrates a machine learning and training model in accordance with various examples of the present disclosure.

FIG. 12 illustrates an example block diagram of a device.

FIG. 13 illustrates an example trip preview generated using the disclosed trip planning method.

FIG. 14 illustrates an example three-dimensional map that may be used to view the trip preview.

FIG. 15 illustrates an example travel planning experience while using the disclosed method.

FIG. 16 illustrates an example input for travel planning using the disclosed travel planning method.

FIG. 17 illustrates an example travel planning experience while using the disclosed method.

FIG. 18 illustrates an example travel planning experience using the disclosed method.

FIG. 19 illustrates an example travel planning model used for trip planning, use during the trip, and the trip reflection.

The figures depict various embodiments for purposes of illustration only. One skilled in the art will readily recognize from the following discussion that alternative embodiments of the structures and methods illustrated herein may be employed without departing from the principles described herein.

### A. Audio Authentication Hardware Key and Detection Ecosystem DETAILED DESCRIPTION

Some embodiments of the present invention will now be described more fully hereinafter with reference to the accompanying drawings, in which some, but not all embodiments of the invention are shown. Various embodiments of the invention may be embodied in many different forms and should not be construed as limited to the embodiments set forth herein. Like reference numerals refer to like elements throughout.

It is to be understood that the methods and systems described herein are not limited to specific methods, specific components, or to particular implementations. It is also to be understood that the terminology used herein is for the purpose of describing particular embodiments only and is not intended to be limiting.

Detecting deepfake audio is becoming increasingly difficult with the ease at which it may be created using available artificial intelligence tools, the quality of sound and sometimes associated video, etc. But deepfake audio invites the spread of misinformation. For example, any technologically savvy person may create a video dubbing a video of the president with completely different speech, and using AI, sync the lip movements with the fake audio.

To address this issue, there may be a need to enable casual users and public figures alike to provide a positive verification that a person is who they say they are and endorse their speech. To display this verification at a system-level may combat the dangers of deepfake audio at the source—the publication of the audio/videos themselves—and prevent the spread of misinformation.

The disclosed subject matter may display a verification credential as a caption of a video or audio clip that has been authenticated by the audio authentication hardware key and detection ecosystem to signal to users that the content is to be authentic and to be “trusted.” The ability to authenticate human speech through the registration and verification of public and private keys associated with audio empowers the underlying information and promotes faith and trust in content.

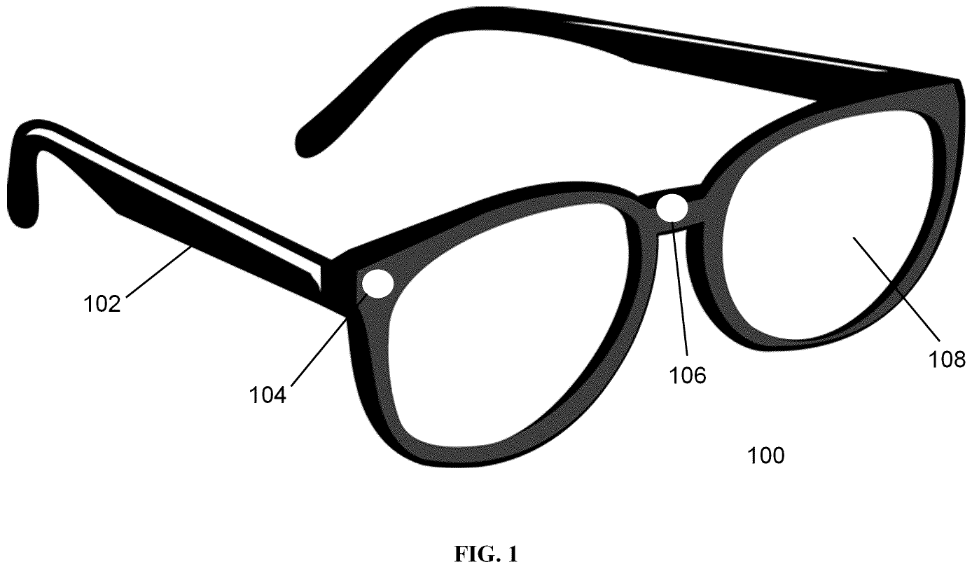

FIG. 1 illustrates an example head-mounted display (HMD) 100 associated with artificial reality content. HMD 100 may include enclosure 102 (e.g., an eyeglass frame), speaker 104, sensor 106, or display 108 (e.g., lenses). In some examples, head-mounted display 100 may be implemented in the form of augmented-reality glasses. Accordingly, display 108 may be at least partially transparent to visible light to allow the user to view a real-world environment through display 108.

HMD 100 design may include speaker 104 that plays an audio code that underlays human speech. An audio code may be played from speaker 104 as signaled by collection of vibrations or audio by sensor 106 on HMD 100. An audio code may be only as audible as the human speech is. The speaker may play an audio code at a frequency higher than the audible range (above 20,000 Hz), or in the standard range of human hearing, similar to hushed white noise. An audio code playback may be adapted to the noise level of the environment to ensure its audibility and detection by the recording.

HMD 100 design may include sensor 106 (e.g., a vibration sensor or a sound sensor). Sensor 106 may detect vibrations or listen for audio. Upon the detection from sensor 106, speaker 104 may output an audio code. HMD 100 may include an audio authentication system to encode the audio code played by speaker 104 with a unique identifier, a timestamp, a transcript of the recorded audio, or a checksum.

Other conceptions of HMD 100 may manifest as any wearable hardware device. Examples may include earrings, necklaces, watches, hats, brooches, pins, or neckties. The consideration here is that HMD 100 may be able to detect vibrations that stem from audio production. As a head-mounted display, a sensor 106 may detect vibrations on the nose bridge from lip movements. As a pair of earrings, a sensor 106 may detect vibrations from jaw muscles used to produce audio. As a necklace or necktie, a sensor 106 may detect vibrations within the chest from expansion of lungs during audio production. Or a sensor 106 may recognize audio in the case of a brooch or watch.

HMD 100 may be registered with a private key via external application. A private key may be recognized by server 210 for identification purposes. A private key may be personalized to the wearer of HMD 100.

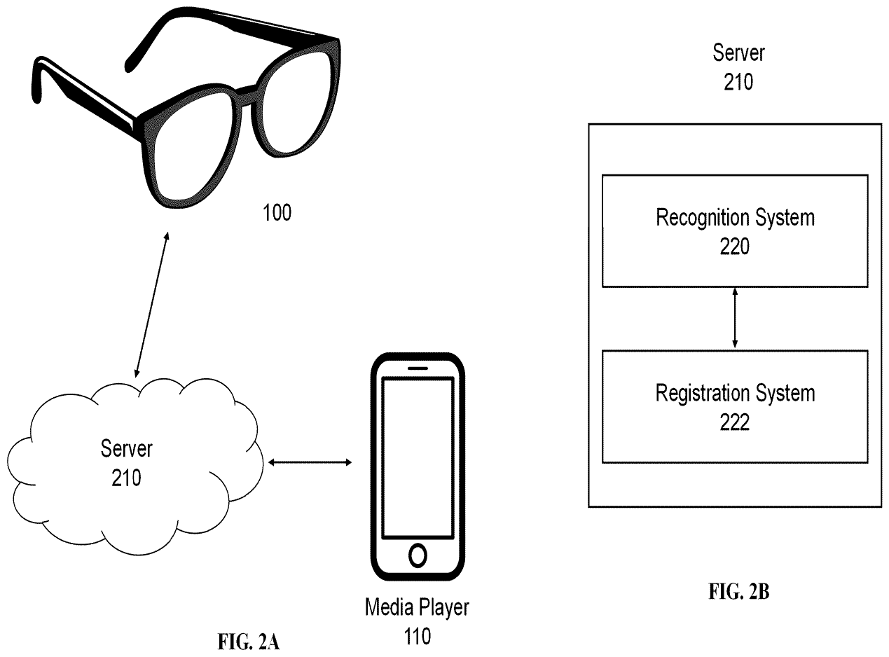

FIG. 2A illustrates an example method for how general aspects of the device may interact. HMD 100, server 210, or media player 110 may be communicatively connected with each other. HMD 100 may transmit an audio code and its associated metadata. Server 210 may receive the audio code or metadata, then may assess the metadata to verify the legitimacy of the audio code alongside the information registered to HMD 100. The verification result may be transmitted by server 210 to media player 110. Media player 110 may display a verification credential alongside the presentation of the audio clip.

Media player 110 may be mobile phone, television, laptop, or tablet. A user may engage with audio or video using the media player 110. The audio clip may be presented on the media player 110 through a social media platform, news channel, podcast library, or video site. Audio or video clips available on the media player 110 may be captioned by a verification credential or catered error message.

As shown in FIG. 2B, the server 210 may include a recognition system 220 or a registration system 222. The recognition system 220 may be used to identify the code signal. The audio code may contain an unencrypted public key, an unencrypted timestamp, an encrypted timestamp, an encrypted speaker transcription, or a checksum. This information may be baked into the audio code as effectively an audio watermark. The recognition system 220 may decrypt the encrypted timestamp and encrypted speaker transcription to process some or all the metadata for the verification of the legitimacy of the audio code alongside the information registered to HMD 100.

The registration system 222 may read the private keys associated with HMD 100. HMD 100 may be assigned a private key. The private key may pair with a public key associated with the audio code outputted by HMD 100. The registration system 222 may read the private key so that the server 210 may compare the public and private keys to see whether they pair. It is contemplated herein that one or more of the functionalities described herein may be executed on one device or module or distributed over multiple devices or modules.

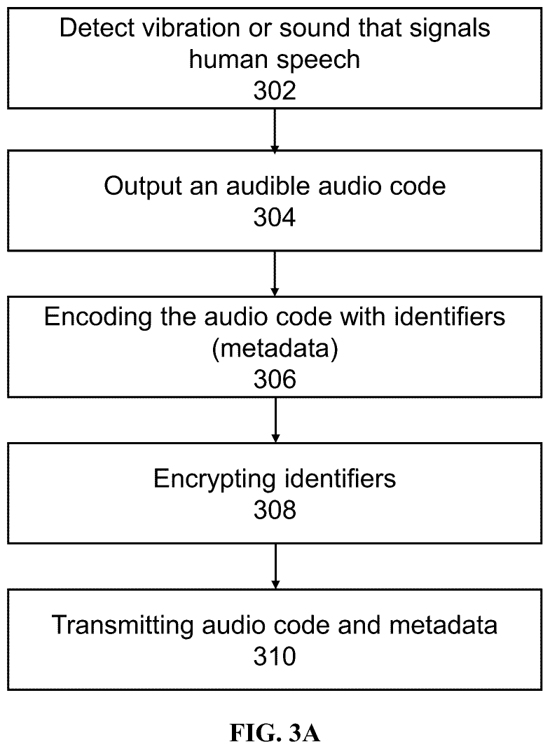

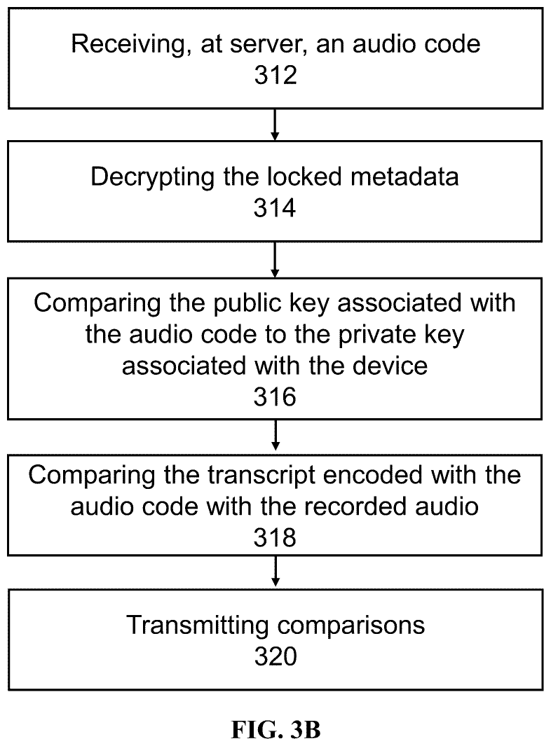

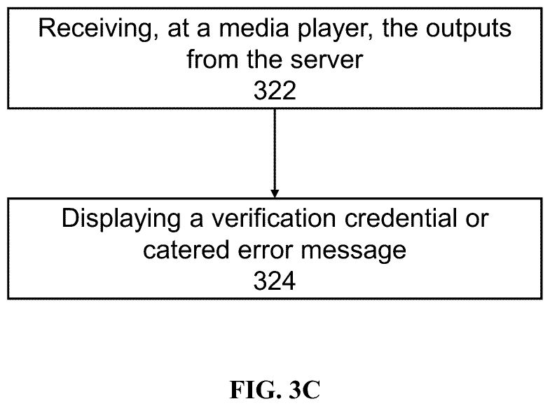

FIG. 3A illustrates a method for outputting an audio clip. HMD 100 is worn in this example as a pair of eyeglasses. With the eyeglasses resting on the nose bridge, the sensor 106 may detect physical vibrations within the facial features to suggest audio production by the wearer. In another example, the sensor 106 may detect vibrations from another body part or hear sound from the wearer to signal the start of the audio output. At the detection of such vibration in step 302, the speaker 104 may output an audible audio code at step 304. The audio code may last as long as the human speech and may underlay the sound of the human speech. At step 306, HMD 100 may encode the outputted audio code with identifiers (also referred to as “metadata”). At step 308, the metadata may undergo a process of encryption to promote the security of the content. At step 310, HMD 100 may transmit the audio code and metadata.

FIG. 3B illustrates a method for processing an audio code by server 210. At step 312, server 210 may receive an audio code from HMD 100. At step 314, the recognition system 220 may decrypt the encrypted timestamp and encrypted speaker transcription to process some or all the metadata for the verification of the legitimacy of the audio code alongside the information registered to HMD 100. The registration system 222 may decrypt the private key associated with HMD 100 to which the audio code originated. At step 316, the server 210 may compare the public and private keys. At step 318, the server 210 may compare the decrypted speaker transcription to the recorded audio. At step 320, the server 210 may transmit the comparisons of the public and private keys and of the speaker transcriptions as the assessment of the authenticity of the audio code.

FIG. 3C illustrates a method for communicating the assessment of the authenticity of an audio code to the user via the media player 110. The media player 110 may receive the outputs from the server 210 at step 322. At step 324, the media player 110 may display as a descriptor to the audio verification credentials or a catered error message. If the public key assigned to the audio code pairs correctly with the private key associated to HMD 100, and the speaker transcription stored in the audio code matches the recorded audio, a media player 110 may display a verified flag and the name of the registered voice on the media player 110 through a social media platform, news channel, podcast library, or video site. If the public key exists but does not match the private key, or the transcripts do not match, then the media player may display that a deepfake may have been detected. If there is no audio code, then the media player may display that no verification could be found.

This first example may demonstrate the functionality of the system in broadcast scenarios. During a televised debate, the authentication hardware worn by the speaker continues to emit its encrypted signal, which is captured by broadcast equipment alongside the primary audio or video. When this content is transmitted to home television sets of viewers, the authenticity of the broadcast may be verified in near real-time by using a mobile application of mobile device that may capture the visual or audio components from a television screen. The mobile device camera or microphone may be directed towards the screen. The application may process the embedded authentication signal and display an overlay confirming the identity of the speaker and the authenticity of the content.

A second example may demonstrate the robustness of the system against sophisticated manipulation attempts. In this scenario, a malicious actor may employ advanced audio processing techniques to separate the authentication signal from the original speech and then may attempt to combine this signal with synthetically generated speech content. The authentication process performed by the system may include the verification of the encrypted transcript against the actual speech content; for example, the authentication speech recognition (ASR) from the signal does not match the ASR the media ran on the video. When this manipulated content is uploaded to the platform, the authentication system may detect the mismatch between the encrypted transcript and the modified speech content, triggering a warning message about the presence of manipulated content.

In implementations where authentication hardware may be lost or stolen, the system may provide a rapid device deauthorization protocol. Upon notification of compromise, the authentication system may immediately invalidate the public key of the authentication hardware device in the registration system and may add it to a revocation list. Subsequently, some or all new recordings that include authentication signals from the compromised device may be automatically flagged as invalid, while previously verified recordings may retain their authentication status up to the time of reported compromise. This temporal-based validation system may ensure swift security response or maintenance of historical recording integrity.

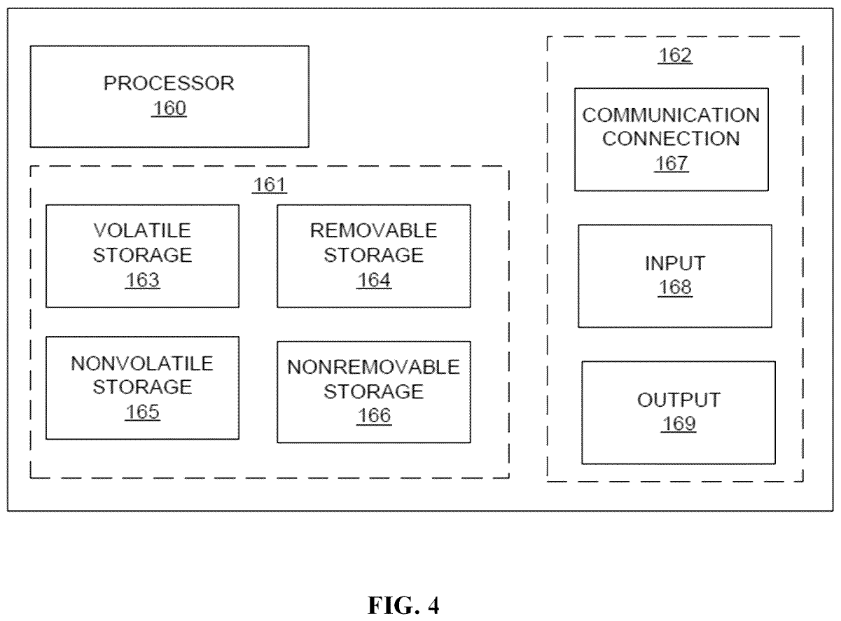

FIG. 4 is an exemplary block diagram of a device, such as HMD 100 or another device 101. In an example, HMD 100 may include hardware or a combination of hardware and software. The functionality to facilitate telecommunications via a telecommunications network may reside in one or combination of devices. A device may represent or perform functionality of one or more devices, such as a component or various components of a cellular broadcast system wireless network, a processor, a server, a gateway, a node, a gaming device, or the like, or any appropriate combination thereof. It is emphasized that the block diagram depicted in FIG. 4 is exemplary and not intended to imply a limitation to a specific implementation or configuration. Thus, HMD 100, for example, may be implemented in a single device or multiple devices (e.g., single server or multiple servers, single gateway or multiple gateways, or single controller or multiple controllers). Multiple network entities may be distributed or centrally located. Multiple network entities may communicate wirelessly, via hardwire, or any appropriate combination thereof.

HMD 100 or another device may comprise a processor 160 or a memory 161, in which the memory may be coupled with processor 160. Memory 161 may contain executable instructions that, when executed by processor 160, cause processor 160 to effectuate operations associated with t-f-dot system, or other subject matter disclosed herein.

In addition to processor 160 and memory 161, HMD 100, or another device may include an input/output system 162. Processor 160, memory 161, or input/output system 162 may be coupled together (coupling not shown in FIG. 4) to allow communications between them. Each portion of HMD 100 or another device 101 may include circuitry for performing functions associated with each respective portion. Thus, each portion may include hardware, or a combination of hardware and software. Input/output system 162 may be capable of receiving or providing information from or to a communications device or other network entities configured for telecommunications. For example, input/output system 162 may include a wireless communication (e.g., Wi-Fi, Bluetooth, or 5G) card. Input/output system 162 may be capable of receiving or sending video information, audio information, control information, image information, data, or any combination thereof. Input/output system 162 may be capable of transferring information with HMD 100 or another device 101. In various configurations, input/output system 162 may receive or provide information via any appropriate means, such as, for example, optical means (e.g., infrared), electromagnetic means (e.g., radio frequency (RF), Wi-Fi, Bluetooth), acoustic means (e.g., speaker, microphone, ultrasonic receiver, ultrasonic transmitter), or a combination thereof. In an example configuration, input/output system 162 may comprise a Wi-Fi finder, a two-way GPS chipset or equivalent, or the like, or a combination thereof.

Input/output system 162 of HMD 100 or another device 101 also may include a communication connection 167 that allows HMD 100 or another device 101 to communicate with other devices, network entities, or the like. Communication connection 167 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 162 also may include an input device 168 such as keyboard, mouse, pen, voice input device, or touch input device. Input/output system 162 may also include an output device 169, such as a display, speakers, or a printer.

Processor 160 may be capable of performing functions associated with telecommunications, such as functions for processing broadcast messages, as described herein. For example, processor 160 may be capable of, in conjunction with any other portion of HMD 100 or another device 101, determining a type of broadcast message and acting according to the broadcast message type or content, as described herein.

Memory 161 of HMD 100 or another device 101 may comprise a storage medium having a concrete, tangible, physical structure. As is known, a signal does not have a concrete, tangible, physical structure. Memory 161, as well as any computer-readable storage medium described herein, is not to be construed as a signal. Memory 161, as well as any computer-readable storage medium described herein, is not to be construed as a transient signal. Memory 161, as well as any computer-readable storage medium described herein, is not to be construed as a propagating signal. Memory 161, as well as any computer-readable storage medium described herein, is to be construed as an article of manufacture.

Herein, a computer-readable storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable storage medium may be volatile, non-volatile, or a combination of volatile and non-volatile, where appropriate.

While the disclosed systems have been described in connection with the various examples of the various figures, it is to be understood that other similar implementations may be used or modifications and additions may be made to the described examples of an audio authentication hardware key and detection ecosystem, among other things as disclosed herein. For example, one skilled in the art will recognize that an audio authentication hardware key and detection ecosystem, among other things as disclosed herein in the instant application, may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure - an audio authentication hardware key and detection ecosystem-as illustrated in the Figures, specific terminology is employed for the sake of clarity. The claimed subject matter, however, is not intended to be limited to the specific terminology so selected.

### B. Mixed Reality Artificial Intelligence Trip Planner

### TECHNOLOGICAL FIELD

Exemplary embodiments of this disclosure relate generally to methods, apparatuses, or computer programs for travel planning using artificial intelligence and mixed reality.

### BACKGROUND

Traditional methods of planning travel may focus primarily on identifying available activities associated with a destination. Creating an optimized itinerary that balances personal interests, time constraints, and geographical logistics may be challenging. Additionally, assessing the true quality and appeal of recommended attractions often proves difficult.

### BRIEF SUMMARY

A trip planning tool may incorporate a machine learning model to take inputs such as a travel destination, duration, activities, or other preferences to generate an itinerary for planned travel. The itinerary may be used by the machine learning model to generate a trip preview, which may be viewed in a two-dimensional (2D) manner or a three-dimensional (3D) manner using mixed reality. During the trip, the tool may be used to provide route guidance, information about stops along the trip, or documentation of the trip using videos or photos. Trip information, which may include, photos, videos, information about the stops, the itinerary, or location data may be compiled to generate a trip reflection which may be viewed.

Methods, systems, or apparatuses with regard to travel planning using a specialized machine learning model are disclosed herein. A method, system, or apparatus may be provided for generating an itinerary; creating a trip preview; viewing the trip preview; receiving route guidance; generating a trip reflection; and viewing the trip reflection.

Some methods, systems, or apparatuses may provide travel planning that allows training of a machine learning model on a dataset of travel information to enable the machine learning model to provide a travel itinerary after being provided with instructions. The approach may enable the use of mixed reality to preview the planned travel. The disclosed method may provide travel guidance and may compile information during a trip to generate a trip reflection which may be viewed after the trip is complete.

Contemporary travel planning techniques may be limited in their ability to use information to make useful recommendations for travel activities, provide a preview of the travel plan, or organize information collected on the trip to provide an enjoyable, accurate recap of the trip. The present disclosure relates to systems or methods for travel planning or review using artificial intelligence (AI) or mixed reality. The presently disclosed method may work in multiple phases: (1) the travel planning phase; (2) the travel execution phase; or (3) the travel review phase.

During the travel planning phase, AI may take into account several parameters to generate a trip itinerary. Those parameters may include the travel destination, duration, trip type, preferred activities, or other parameters. Mixed reality may be integrated to enable a preview of the travel plan using the itinerary or electronic devices with virtual reality software, along with immersive 3D views for each of the itinerary points in VR.

During the travel execution phase, portable devices may enable the use of the itinerary for guidance between travel stops, while providing information on landmarks during the trip. The portable device may be used during the trip to capture moments using photo or video which may be compiled to create a trip reflection.

The travel review may occur when the trip is complete. After the trip is completed, a trip reflection may be generated using photos, videos, the trip itinerary, global positioning system (GPS) data, or descriptions. Electronic devices may be used to view the trip reflection.

The disclosed subject matter may enable several innovations. The disclosed technique may enable the use of AI to generate a personalized travel itinerary based on several parameters. The travel itinerary may be planned alone or in a networked experience across several locations. The disclosed technique may further enable the use of mixed reality to preview the trip with the aid of 3-dimensional views and maps.

The disclosed method may use portable devices to provide information during the trip about landmarks, including background information and location information which may be used for navigation. The disclosed method may further enable navigation between stops or landmarks using voice navigation with portable devices while providing real time updates on factors that may impact the trip. The disclosed method may capture moments of the trip using a portable device to take photos or video, which may be stored for review. The disclosed method may then be used to generate a trip reflection which may be viewed in a video. The trip reflection may be used to provide a chronologically or geographically accurate representation of the trip using trip information such as the travel itinerary, photos, video, location descriptions, or other relevant information.

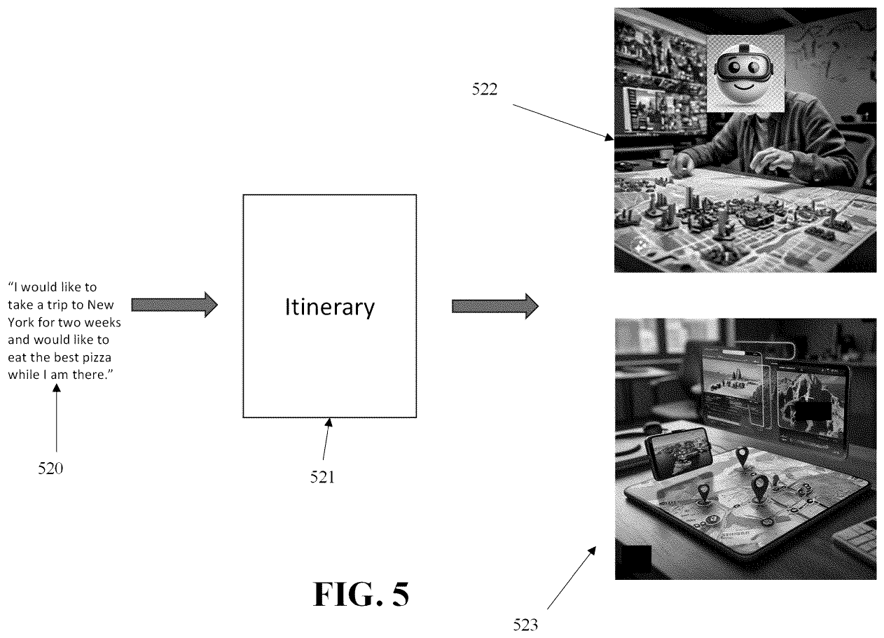

FIG. 5 illustrates an example trip planning model. An instruction 520 may be provided detailing information about a future trip. The instruction 520 may include the destination, duration, trip occasion, preferred activities, or other information. An example instruction (e.g., instruction 520) may be given as “I would like to take a trip to New York for two weeks and would like to eat the best pizza while I am there.” An instruction may be given via text, verbally, or through any interface that may be used to provide information to a computer or portable devices. An itinerary (e.g., itinerary 521) may contain a travel plan, based on the travel instructions provided. The travel plan may include information such as travel dates, destination, hotel and restaurant reservations, or a schedule of activities. Using the itinerary, a trip preview (e.g., trip preview 522 or trip preview 523) may be generated to enable a preview of the planned route of travel, landmarks, stops, and the area of travel. The trip preview (e.g., trip preview 522 or trip preview 523) may be viewed in virtual reality (VR), mixed reality (MR), or augmented reality (AR), which may be used interchangeably herein for simplicity.

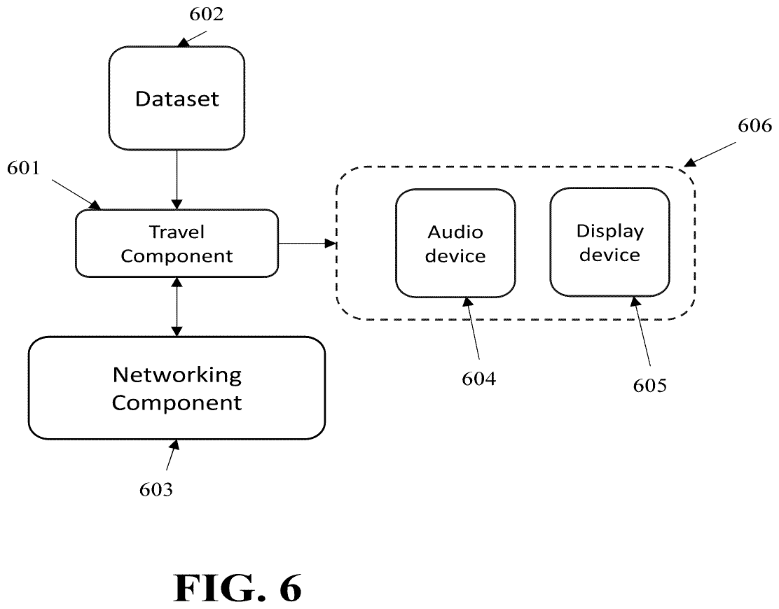

FIG. 6 illustrates an example artificial intelligence (AI) trip planner model for the trip planning phase. A travel component 601 may include a machine learning (ML) model and may generate a travel itinerary 621 after receiving instruction 520. The machine learning model may be trained on a dataset 602 to enable the model to generate itinerary 521 based on a location and activities in the location. Dataset 602 may include examples of travel itineraries, geographic data, landmark location information, tourist destinations, and activities at locations. The instructions 520 may include a travel destination, duration of travel, occasion for the trip, preferred activities, and other relevant information. Based on the instructions, travel component 601 may generate an itinerary 521 for the trip. A networking component 603, may be used to enable travel planning across multiple stations (e.g., for multiple users in collaboration) for a single trip. Networking component 603 may enable multiple stations to add or edit instructions for a given trip. After receiving instructions or edits from networking component 603, the travel component 601 may incorporate the added or edited instructions to generate an itinerary. Travel component 601 may use the itinerary 521 to generate a 2-dimensional (2D) or 3-dimensional (3D) trip preview (e.g., trip preview 522 or trip preview 523) of the planned travel.

A preview component 606 may enable a preview of the planned travel using a 2 dimensional or 3-dimensional trip preview (e.g., trip preview 522 or trip preview 523) using virtual reality, mixed reality, or augmented reality. Preview component 606 may include audio device 604 or display device 605. Display device 605 may be used to view the generated trip preview. Multiple display devices 605 may be used to view the trip preview. A trip preview (e.g., trip preview 522 or trip preview 523) may be viewed in multiple locations through multiple display devices over a network using a networking component (e.g., networking component 603). It is contemplated that the methods or systems disclosed herein may be executed in a collaborative manner using multiple devices. The use of the term “component” herein merely indicates that a functional or physical component, or device, may be used to execute the indicated task.

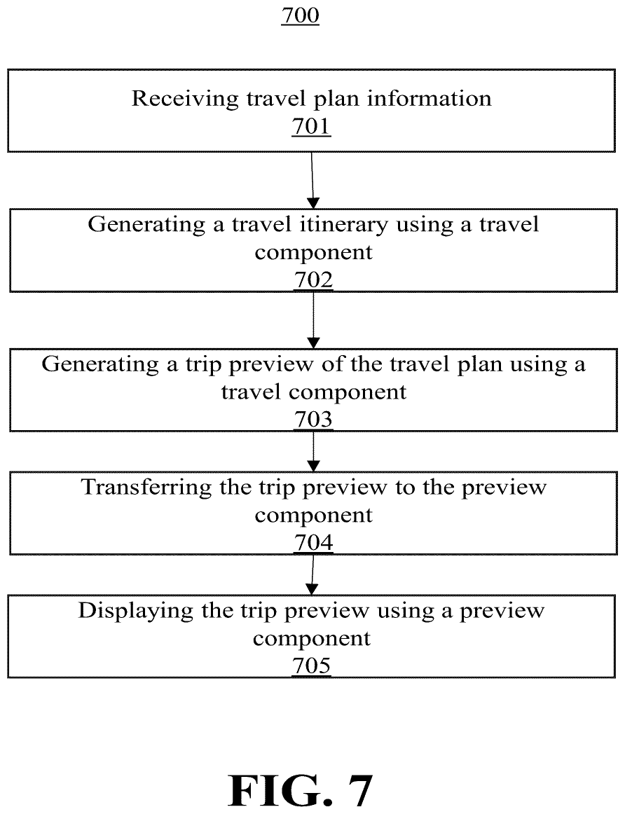

FIG. 7 illustrates an example method 700 for generating an itinerary 521 and trip preview 522. At step 701, an instruction 520 may be received. At step 702, travel component 601 may generate a travel itinerary. At step 703 the travel component 601 may generate a trip preview based on the itinerary 521. At step 704, travel component 601 may transfer the trip preview to preview component 606. At step 705 the preview component may display the trip preview using a display device. Multiple display devices may be used to display the trip preview. A trip preview may be viewed in multiple locations through multiple display devices over a network using a networking component (e.g., networking component 603). The trip preview may be displayed in 2D or 3D using virtual reality, mixed reality, or augmented reality. It is contemplated that the methods or systems disclosed herein may be executed in a collaborative manner with other user devices. The methods or systems herein may be associated with and executed using a messaging application.

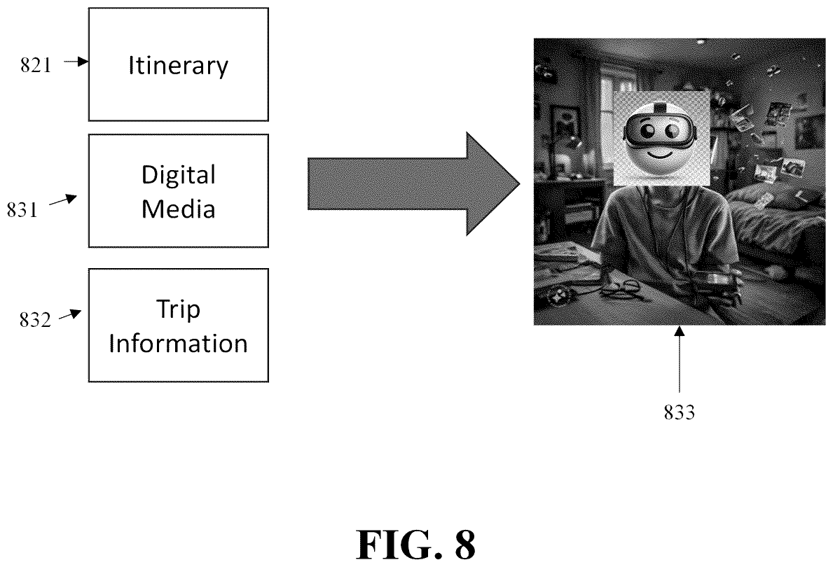

FIG. 8 illustrates an example trip reflection model. An itinerary 521, digital media (e.g., digital media 831), and other trip information (e.g., trip information 832) may be compiled by storage 911. Trip information 832 may include landmarks, descriptions of landmarks, or information about activities completed along the trip. Storage 911 may then be used to generate a trip reflection 833. Trip reflection 833 may be a visual or audio presentation of the completed trip showing that may include media collected manually or automatically during the trip, the trip itinerary, or information about other activities completed during the trip.

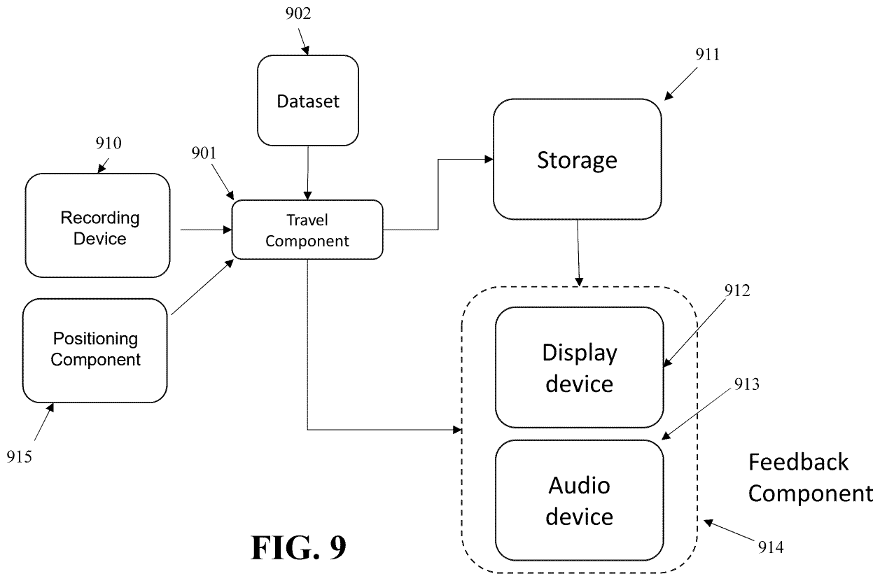

FIG. 9 illustrates an example AI trip planner model for the trip execution and review phases. A travel component 901 may include a ML model that may be trained on a dataset 902 to enable the model to provide location and routing information while traveling. Dataset 902 may include examples of travel itineraries, geographic data, landmark location information, tourist destinations, and activities at locations. Travel component 901 may provide routing information. Updates to the route of travel and issues impacting the route may be provided by travel component 901. Along the route of travel, travel component 901 may provide information, in addition to the geographic data, on landmarks or stops. Travel component 901 may identify landmarks and stops based on the geographical location.

Travel component 901 may provide routing directions via a feedback component 914. Feedback component 914 may include a display device 912 or an audio device 913. Feedback component 914 may be used to provide visual or text-based routing directions through display device 912. Feedback component 914 may be used to provide audio for routing directions through audio device 913. Feedback component 914 may include multiple display devices. Feedback component 914 may also include multiple audio devices.

A recording device 910 may be used to record digital media 831. Travel component 901 may be used to identify landmarks recorded and to provide information (in addition to their geographical information) on the recorded landmarks. The landmarks may be identified based on photos, videos, or their geographical location by travel component 901. Digital media 831 recorded by recording device 910 may be uploaded to a storage 911 by travel component 901.

Storage 911 may be used to compile trip information. Compiled trip information may include an itinerary 821, digital media 831, landmarks, descriptions of the landmarks, or information about activities completed along the trip (e.g., trip information 832). Storage 911 may generate trip reflection 833 using the compiled trip information. Trip reflection 833 may be displayed using feedback component 914. Feedback component 914 may be used to display trip reflection 833 using display device 912. Multiple display devices may be used to display the trip reflection. An audio presentation of trip reflection 833 may be presented using feedback component 914. Feedback component 914 may be used to present an audio presentation of trip reflection 833 using audio device 913. Multiple audio devices may be used to present an audio presentation of the trip reflection.

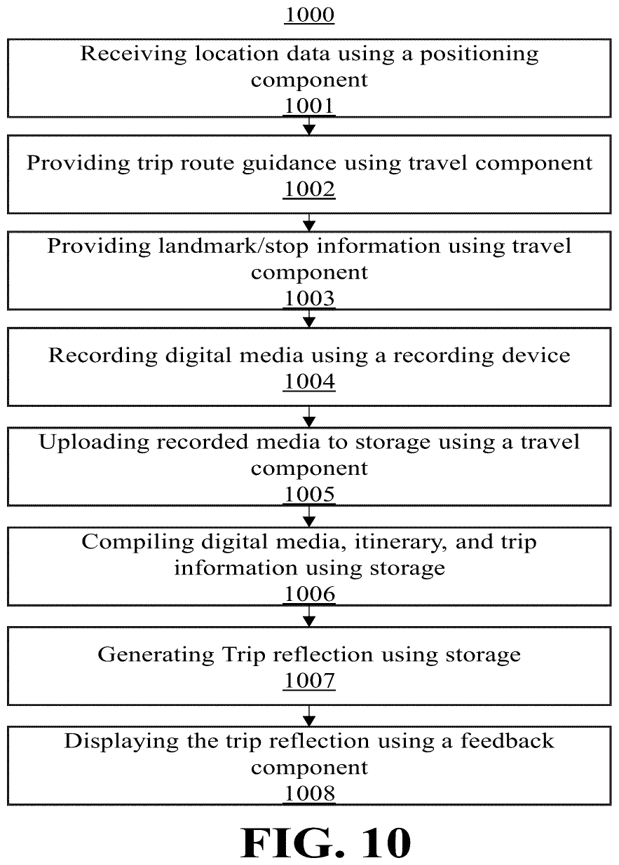

FIG. 10 illustrates an example method 1000 for providing travel guidance and generating a trip reflection 833. At step 1001, location data may be provided using a positioning component 915. At step 1002, trip route guidance may be provided using travel component 901. At step 1003, information about landmarks and stops may be provided using travel component 901. Travel component 901 may be trained to provide route guidance, identify landmarks, and provide information on geographical points (e.g., landmarks and stops) using dataset 902. At step 1004, digital media (e.g., photos or videos) may be recorded using recording device 910. At step 1005, recorded media may be uploaded to storage 911 using travel component 901.

At step 1006, storage may be used to compile the digital media, itinerary 821, and other trip information (e.g., trip information 832). Trip information 832 may include stops, overview information of stops, or information about activities completed along the trip. At step 1007, a trip reflection (e.g., trip reflection 833) may be generated using storage 911. At step 1008, trip reflection 833 may be displayed using feedback component 914. Feedback component 914 may display trip reflection 1833 using display device 912. Multiple display devices may be used to display the trip reflection. Feedback component 914 may use audio device 913 to provide an audio presentation of trip reflection 833. It is contemplated that the methods or systems disclosed herein may be executed in a collaborative manner using multiple devices.

Methods, systems, or apparatuses with regard to travel planning using a specialized machine learning model are disclosed herein. A method, system, or apparatus may be provided for generating an itinerary using a travel model; creating a trip preview using a travel component; viewing the trip preview using a preview component; receiving route guidance using a travel component; generating a trip reflection using a travel component; and viewing the trip reflection using a feedback component.

A method for travel planning, comprising: receiving travel plan information; generating a travel itinerary; generating a trip preview of the travel plan; transferring the trip preview; and displaying the trip preview. The travel component may comprise a machine learning model that may be trained on a dataset comprising examples of travel itineraries, geographic data, landmark location information, tourist destinations, and activities at locations. The travel component may be configured to receive travel plan information by voice or text. Travel plan information may be received from multiple devices from multiple stations using a networking component. The preview component may comprise one or more display devices or one or more audio devices. The preview component may be configured to display a 2D or 3D trip preview using virtual reality, mixed reality, or augmented reality. The method may include all combinations (including the removal or addition of steps) in this paragraph and previous paragraphs are contemplated in a manner that is consistent with the other portions of the detailed description.

A method for providing travel guidance, comprising: receiving location information using a positioning component 915; providing trip route guidance using a travel component; and providing landmark and stop information using a travel component. The travel component may comprise a machine learning model that may be trained on a dataset comprising examples of travel itineraries, geographic data, landmark location information, tourist destinations, and activities at locations. The travel component may be configured to receive voice or text commands. The travel component may be configured to provide audio or text-based guidance.

A method for travel review, comprising: recording digital media using a recording device; uploading recorded media to storage using a travel component; compiling digital media, an itinerary, and trip information using storage; generating a trip reflection using storage; and displaying the trip reflection using a feedback component. The travel component may comprise a machine learning model that may be trained on a dataset comprising examples of travel itineraries, geographic data, landmark location information, tourist destinations, and activities at locations. The travel component may be configured to receive voice or text-based commands. The travel component may be configured to identify landmarks and stops using location or images. The trip information may include stops, overview information of stops, or information about activities completed along the trip. The feedback component may comprise one or more display devices or one or more audio devices.

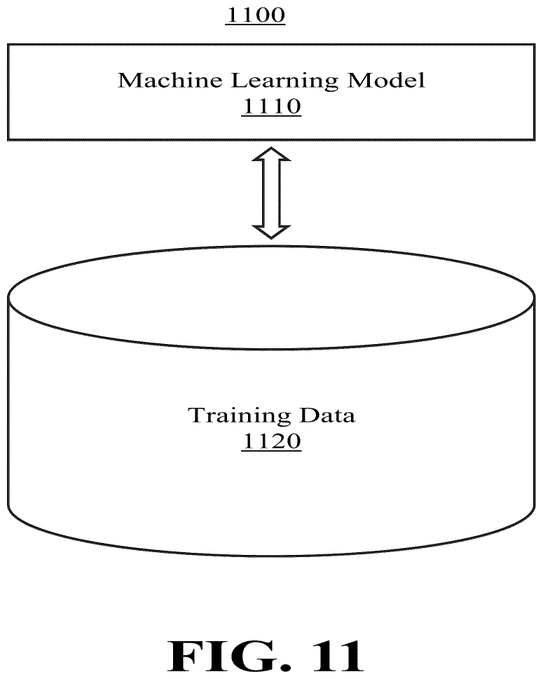

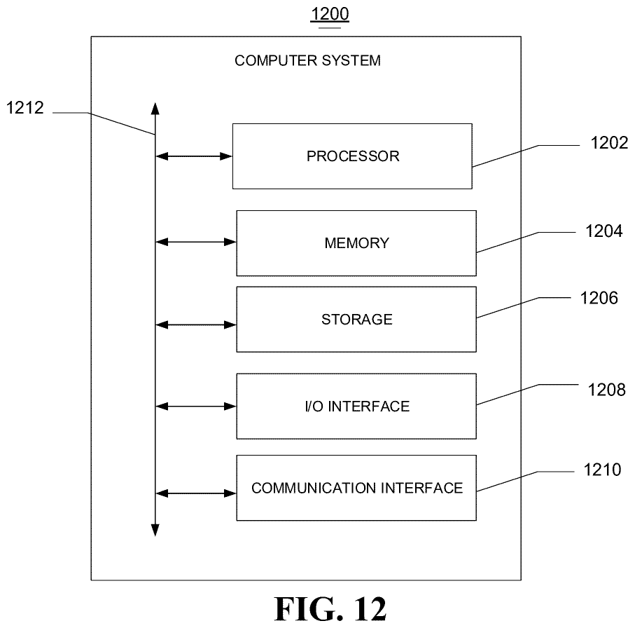

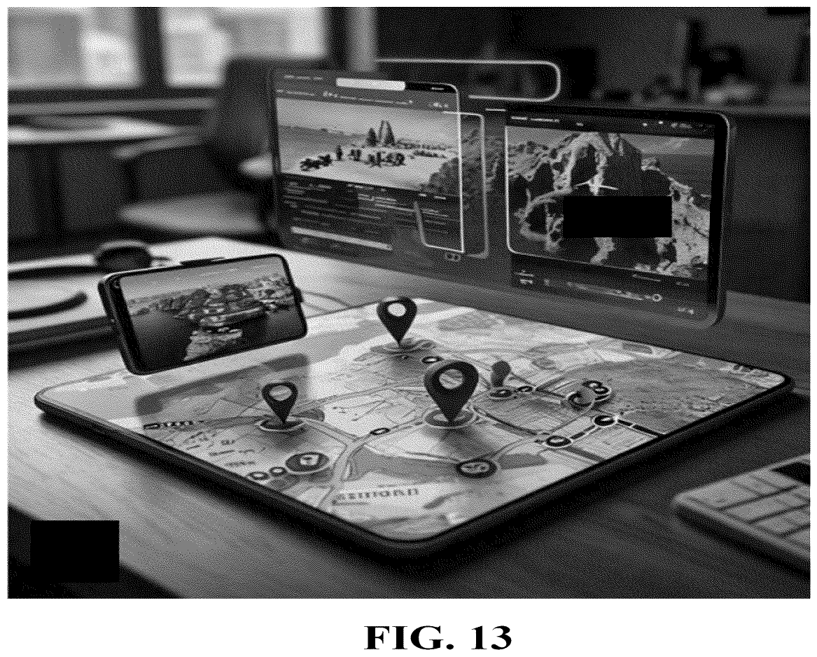

FIG. 11 illustrates a framework 1100 employed by a software application (e.g., computer code, a computer program) for travel planning using AI and mixed reality, in accordance with aspects discussed herein. The framework 1100 may be hosted remotely. Alternatively, framework 1100 may reside within a travel planning model and may be processed by the computing system 1200 shown in FIG. 12. The machine Learning Model 1110 may be operably coupled with the stored training data 1120 in a database. As referred to herein, Machine Learning (ML), Neural Network (NN), Artificial Intelligence (AI), and Large Language Model (LLM) are generally used interchangeably herein.

In an example, the training data 1120 may include attributes of thousands of objects. For example, the object(s) may be identified or associated with user profiles, posts, photographs/images, videos, augmented reality data, sensor data (e.g., capacitive based sensors, magnetic based sensors, resistive based sensors, pressure-based sensors, or audio-based sensors), or the like. The training data 1120 employed by machine learning model 1110 may be fixed or updated periodically. Alternatively, training data 1120 may be updated in real time or near real time based upon the evaluations performed by machine learning model 1110 in non-training mode.

In operation, the machine learning model 1110 may evaluate attributes of images, audio, videos, capacitance, resistance, or other information obtained by hardware (e.g., sensors, peripherals, etc.). For example, aspects of a user profile, posts, images, resistance, capacitance, audio, pressures, size, shape, orientation, position of an object and the like may be ingested and analyzed. The attributes of any of the above may then be compared with respective attributes of stored training data 1120 (e.g., prestored objects). The likelihood of similarity between each of the obtained attributes and the stored training data 1120 (e.g., prestored objects) may be given a determined confidence score. In one example, if the confidence score exceeds a predetermined threshold, the attribute is included in an instruction that is ultimately communicated, which may be to a user via a user interface of a computing device (e.g., computing system 1200). The sensitivity of sharing more or less attributes may be customized based upon the needs of the particular device.

FIG. 12 illustrates an example computer system 1200. One or more computer systems 1200 perform one or more steps of one or more methods described or illustrated herein. In examples, software running on one or more computer systems 1200 performs one or more steps of one or more methods described or illustrated herein or provides functionality described or illustrated herein. Examples include one or more portions of one or more computer systems 1200. Herein, reference to a computer system may encompass a computing device, and vice versa, where appropriate. Moreover, reference to a computer system may encompass one or more computer systems, where appropriate.

The computer system 1200 includes a processor 1202 and memory 1204. The memory 1204 stores instructions that, when executed by the processor 1202, cause the computer system 1200 to implement the travel planning functionality described herein. The computer system 1200 may be communicatively connected with a travel component 901, preview component 606, or feedback component 914.

This disclosure contemplates any suitable number of computer systems 1200. This disclosure contemplates computer system 1200 taking any suitable physical form. As example and not by way of limitation, computer system 1200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1200 may include one or more computer systems 1200; be unitary or distributed; span multiple locations; span multiple machines; span multiple data centers; or reside in a cloud, which may include one or more cloud components in one or more networks. Where appropriate, one or more computer systems 1200 may perform without substantial spatial or temporal limitation one or more steps of one or more methods described or illustrated herein. As an example, and not by way of limitation, one or more computer systems 1200 may perform in real time or in batch mode one or more steps of one or more methods described or illustrated herein. One or more computer systems 1200 may perform at different times or at different locations one or more steps of one or more methods described or illustrated herein, where appropriate.

In examples, computer system 1200 includes a processor 1202, memory 1204, storage 1206, an input/output (I/O) interface 1208, a communication interface 1210, and a bus 1212 (e.g., communication bus). Although this disclosure describes and illustrates a particular computer system having a particular number of particular components in a particular arrangement, this disclosure contemplates any suitable computer system having any suitable number of any suitable components in any suitable arrangement.

In examples, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage 1206; decode and execute them; and then write one or more results to an internal register, an internal cache, memory 1204, or storage 1206. In particular embodiments, processor 1202 may include one or more internal caches for data, instructions, or addresses. This disclosure contemplates processor 1202 including any suitable number of any suitable internal caches, where appropriate. As an example, and not by way of limitation, processor 1202 may include one or more instruction caches, one or more data caches, and one or more translation lookaside buffers (TLBs). Instructions in the instruction caches may be copies of instructions in memory 1204 or storage 1206, and the instruction caches may speed up retrieval of those instructions by processor 1202. Data in the data caches may be copies of data in memory 1204 or storage 1206 for instructions executing at processor 1202 to operate on; the results of previous instructions executed at processor 1202 for access by subsequent instructions executing at processor 1202 or for writing to memory 1204 or storage 1206; or other suitable data. The data caches may speed up read or write operations by processor 1202. The TLBs may speed up virtual-address translation for processor 1202. In particular embodiments, processor 1202 may include one or more internal registers for data, instructions, or addresses. This disclosure contemplates processor 1202 including any suitable number of any suitable internal registers, where appropriate. Where appropriate, processor 1202 may include one or more arithmetic logic units (ALUs); be a multi-core processor; or include one or more processors 1202. Although this disclosure describes and illustrates a particular processor, this disclosure contemplates any suitable processor.

In examples, memory 1204 includes main memory for storing instructions for processor 1202 to execute or data for processor 1202 to operate on. As an example, and not by way of limitation, computer system 1200 may load instructions from storage 1206 or another source (such as, for example, another computer system 1200) to memory 1204. Processor 1202 may then load the instructions from memory 1204 to an internal register or internal cache. To execute the instructions, processor 1202 may retrieve the instructions from the internal register or internal cache and decode them. During or after execution of the instructions, processor 1202 may write one or more results (which may be intermediate or final results) to the internal register or internal cache. Processor 1202 may then write one or more of those results to memory 1204. In particular embodiments, processor 1202 executes only instructions in one or more internal registers or internal caches or in memory 1204 (as opposed to storage 1206 or elsewhere) and operates only on data in one or more internal registers or internal caches or in memory 1204 (as opposed to storage 1206 or elsewhere). One or more memory buses (which may each include an address bus and a data bus) may couple processor 1202 to memory 1204. Bus 1212 may include one or more memory buses, as described below. In examples, one or more memory management units (MMUs) reside between processor 1202 and memory 1204 and facilitate accesses to memory 1204 requested by processor 1202. In particular embodiments, memory 1204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 1204, where appropriate. Although this disclosure describes and illustrates particular memory, this disclosure contemplates any suitable memory.

In examples, storage 1206 includes mass storage for data or instructions. As an example, and not by way of limitation, storage 1206 may include a hard disk drive (HDD), a floppy disk drive, flash memory, an optical disc, a magneto-optical disc, magnetic tape, or a Universal Serial Bus (USB) drive or a combination of two or more of these. Storage 1206 may include removable or non-removable (or fixed) media, where appropriate. Storage 1206 may be internal or external to computer system 1200, where appropriate. In examples, storage 1206 is non-volatile, solid-state memory. In particular embodiments, storage 1206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1206 taking any suitable physical form. Storage 1206 may include one or more storage control units facilitating communication between processor 1202 and storage 1206, where appropriate. Where appropriate, storage 1206 may include one or more storages 1206. Although this disclosure describes and illustrates particular storage, this disclosure contemplates any suitable storage.

In examples, I/O interface 1208 includes hardware, software, or both, providing one or more interfaces for communication between computer system 1200 and one or more I/O devices. Computer system 1200 may include one or more of these I/O devices, where appropriate. One or more of these I/O devices may enable communication between a person and computer system 1200. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1208 for them. Where appropriate, I/O interface 1208 may include one or more device or software drivers enabling processor 1202 to drive one or more of these I/O devices. I/O interface 1208 may include one or more I/O interfaces 1208, where appropriate. Although this disclosure describes and illustrates a particular I/O interface, this disclosure contemplates any suitable I/O interface.

In examples, communication interface 1210 includes hardware, software, or both providing one or more interfaces for communication (such as, for example, packet-based communication) between computer system 1200 and one or more other computer systems 1200 or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1210 for it. As an example, and not by way of limitation, computer system 1200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1200 may include any suitable communication interface 1210 for any of these networks, where appropriate. Communication interface 1210 may include one or more communication interfaces 1210, where appropriate. Although this disclosure describes and illustrates a particular communication interface, this disclosure contemplates any suitable communication interface.

In particular embodiments, bus 1212 includes hardware, software, or both coupling components of computer system 1200 to each other. As an example and not by way of limitation, bus 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1212 may include one or more buses 1212, where appropriate. Although this disclosure describes and illustrates a particular bus, this disclosure contemplates any suitable bus or interconnect.

The disclosed subject matter may be utilized via voice commands to interact with cutting-edge mixed reality technology. Generative AI may be used to plan a trip. The trip planner may take the destination, duration, trip type, and any other important parameter, such as preferred activities, to generate a travel itinerary. The disclosed technology may be used in a network of multiple users to plan or modify a trip, and the itinerary may be exported to multiple applications. Reservations at destinations (e.g., restaurants and hotels) may be made utilizing the disclosed technology.

Furthermore, the disclosed technology may utilize mixed reality to provide a visual preview of the trip. The visual preview may include the use of a map to view the planned stops for the trip, day plan, route between stops, and information on each stop. Portable electronics, including headset, cell phone, laptop, tablet, etc. may be used to view the trip. The trip planner may display a 3D map for the trip preview. Virtual reality may be utilized to experience an immersive view of the trip.

During the trip, the disclosed technology may be utilized to record photos and videos of the trip. The disclosed technology may be used to provide information to the user by utilizing portable technology (e.g., headset, cell phone, tablet, etc.).

FIG. 13 illustrates an example trip preview generated using the disclosed trip planning method. The disclosed travel planning method may use generative AI to generate a map with routing information based on an itinerary that may be developed by the AI model. A trip preview may be generated using the trip planning method. The trip preview may be viewed using multiple devices. Multiple devices from multiple locations may view the trip preview over a network. The trip preview may be viewed using VR, MR, or AR. The disclosed method may enable the use of a trip preview to plan a trip to a destination and view the destination in VR/MR/AR. While viewing the destination, the local destination area may be viewed. The route of travel between landmarks or stops may also be viewed. The landmarks or stops may be identified with markers on the trip preview. Generative AI may be utilized to generate an itinerary for the trip that schedules route, stops, and activities based on the destination and trip preferences.

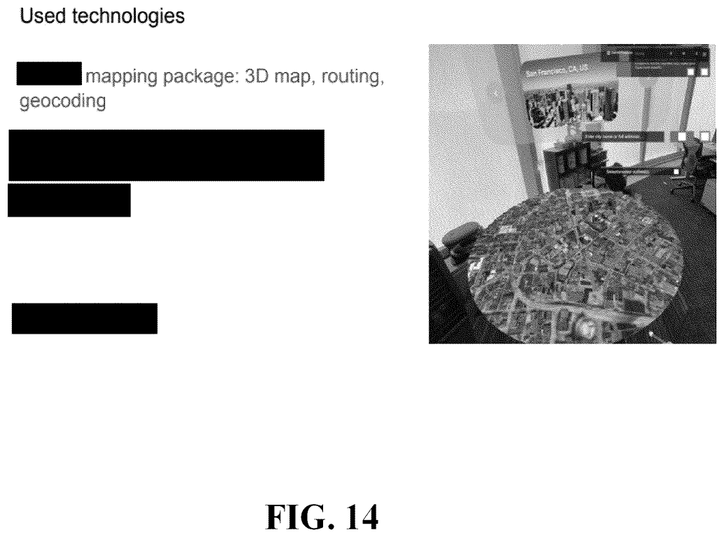

FIG. 14 illustrates an example 3-dimensional map that may be used to view the trip preview. VR/MR/AR may be used to view the trip preview. The trip preview may be viewed using multiple devices over multiple location using a network.

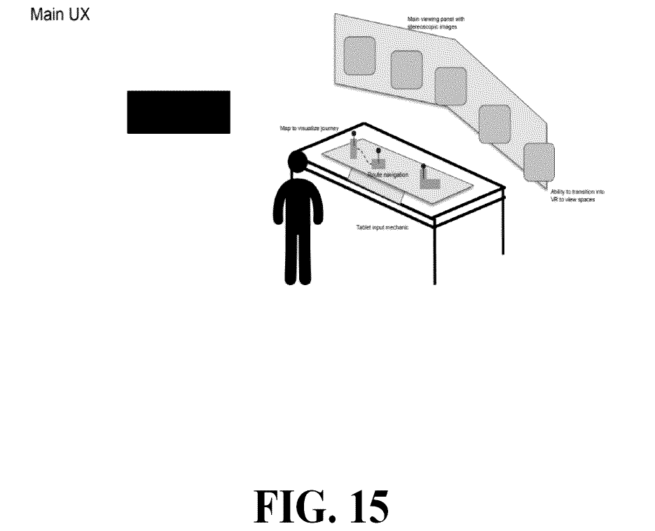

FIG. 15 illustrates an example travel planning experience while using the disclosed method. Multiple devices may be used to plan and view the trip. AR/MR/VR may be used to view a map of the trip destination in 2D or 3D. The map may provide a visualization of the trip with a route and stops created by generative AI based on the trip preferences.

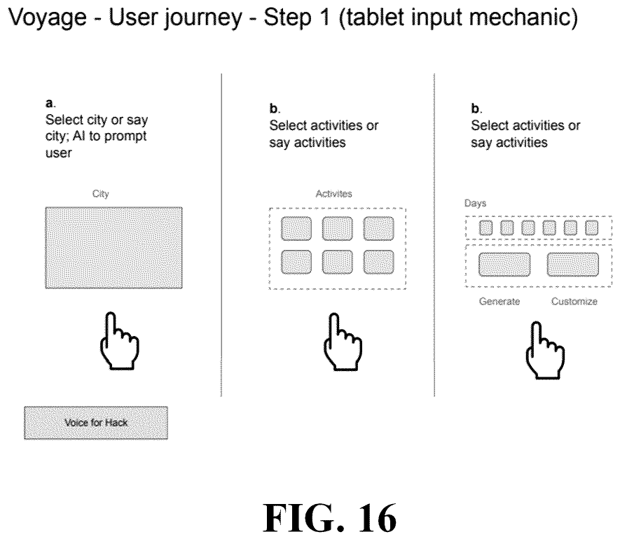

FIG. 16 illustrates an example input for travel planning using the disclosed travel planning method. The disclosed method may take text or voice inputs for travel planning, which may be used to generate an itinerary. The disclosed travel planning method may take inputs such as the destination city, duration, or activities to generate the itinerary.

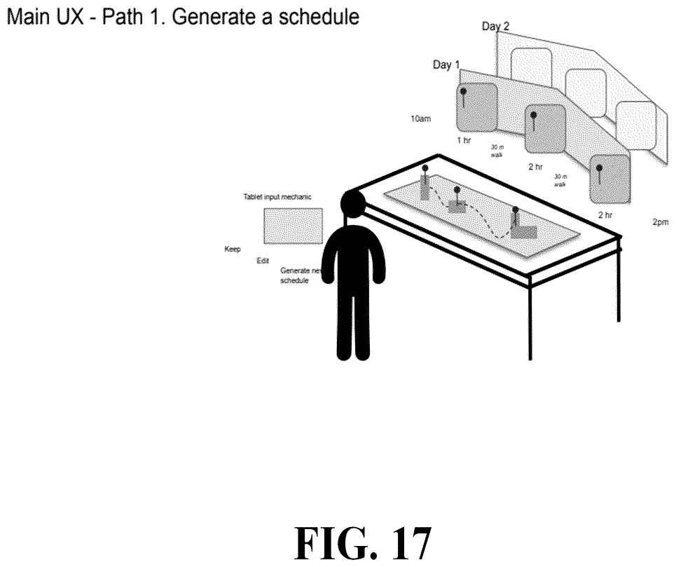

FIG. 17 illustrates an example travel planning experience while using the disclosed method. The disclosed travel planning method may take voice or text input to create an itinerary. Example input data taken in the disclosed method may include the trip destination, duration, planned activities, and preferences. The disclosed travel method may use generative AI to generate an itinerary that takes the input information into account, along with geographic data, to plan and organize the trip based on the input data. The disclosed method may use the itinerary to create a trip preview to display a map with route and stop information to display the trip plan. The trip preview may be viewed using multiple devices in 2D or 3D. The disclosed method may use VR/MR/AR to display the trip preview. The trip preview may be organized in multiple ways. A trip preview may display a selected day from the itinerary or based on select parameters.

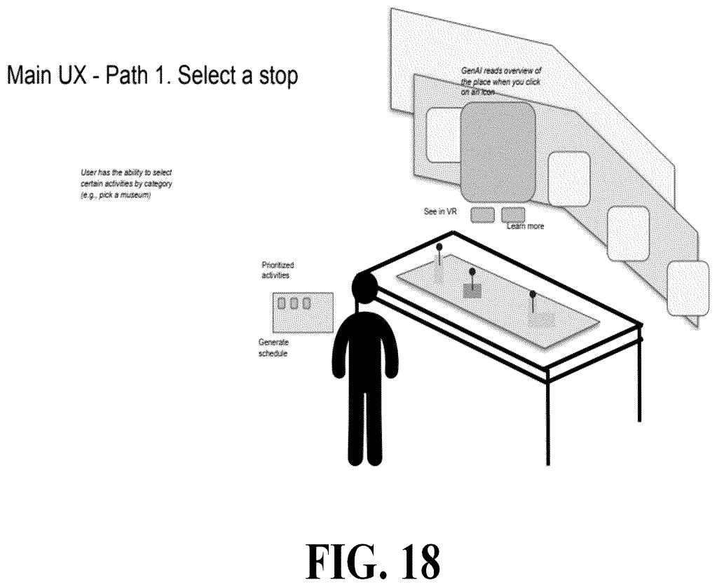

FIG. 18 illustrates an example travel planning experience using the disclosed method. The disclosed travel planning method may take voice or text input to create an itinerary. The itinerary may be used in the disclosed method to create a trip preview. The trip preview may be viewed over multiple devices in 2D or 3D. The trip preview may include a map, routing information, and stops generated by a generative AI model. A stop or landmark may be selected in the trip preview, and overview information about the selected place may be displayed.

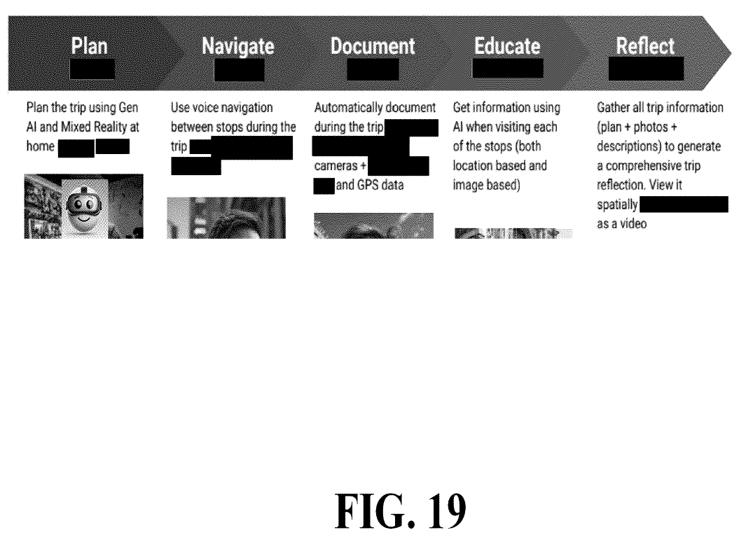

FIG. 19 illustrates an example travel planning model used for trip planning, use during the trip, and the trip reflection. The disclosed travel planning model may use generative AI and VR/MR/AR to plan and preview a trip. The trip preview may be viewed using multiple devices in 2D or 3D. While the trip is being executed, the disclosed subject matter may be used to provide voice navigation. The disclosed method may additionally document the trip using a device to record video or take photos. The disclosed method may include GPS data to record the trip. The disclosed method may use AI to provide information on any stops or landmarks based on the location or image of the stop or landmark. All trip information may be gathered to generate a comprehensive trip reflection, which may be viewed.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

While the disclosed systems have been described in connection with the various examples of the various figures, it is to be understood that other similar implementations may be used or modifications and additions may be made to the described examples of the disclosed travel planning components, among other things as disclosed herein. For example, one skilled in the art will recognize that the disclosed travel planning method, among other things as disclosed herein in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—the disclosed travel planning method—as illustrated in the Figures, specific terminology is employed for the sake of clarity. The claimed subject matter, however, is not intended to be limited to the specific terminology so selected.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed:

1. An apparatus comprising:
one or more sensors;
one or more speakers, that when executed by the one or more sensors, cause the apparatus to output an audio code; and
one or more processors, that when the audio code is finalized, encode the audio code with identifiers readable by the apparatus to identify and authenticate the audio.

2. The apparatus of claim 1, further comprising:
a sensor configured to detect vibration or sound that signals human speech, wherein the one or more processors are further configured to:
output an audible audio code;
encode the audio code with a series of identifiers;
encrypt the private identifiers; and
transmit the audio code and its associated metadata.

3. The apparatus of claim 2, wherein the sensor is configured to detect vibration from facial movements created by lip movements when producing human speech.

4. The apparatus of claim 2, wherein the one or more speakers outputs the audio code.

5. The apparatus of claim 2, wherein the audio code is encoded with a public key, two or more timestamps, a speaker transcription, and a checksum.

6. The apparatus of claim 4, wherein the audio code is played to be audible as the human speech.

7. The apparatus of claim 4, wherein the one or more speakers are configured to play the audio code at a frequency higher than an audible range above 20,000 Hertz, or in a standard range of human hearing associated with hushed white noise.

8. The apparatus of claim 5, wherein the metadata is tagged for a checksum to ensure the identifiers, or audio file is uncorrupted by the audio transfer.

9. The apparatus of claim 5, the one or more processors are configured to:
encrypt a time stamp or encrypt a speaker transcription.

10. A method for travel planning, comprising:
receiving travel plan information;
generating a travel itinerary;
generating a trip preview of the travel plan;
transferring the trip preview to a device; and
displaying the trip preview.

11. The method of claim 10, wherein a travel component comprises a machine learning model that is trained on a dataset comprising:
travel itineraries:
geographic data;
landmark location information;
tourist destinations; and
activities at locations.

12. The method of claim 10, further comprising:
receiving, by a travel component, travel plan information by voice data or text data.

13. The method of claim 10, wherein the travel plan information is received from multiple devices, or from multiple stations, using a networking component.

14. The method of claim 10, wherein a preview component comprises:
one or more display devices; and
one or more audio devices.

15. The method of claim 10, further comprising:
displaying, by a preview component, a two-dimensional (2D) and a three-dimensional (3D) trip preview using virtual reality, mixed reality, or augmented reality.

16. A method for providing travel guidance, comprising:
receiving location information using a positioning component;
providing trip route guidance using a travel component; and
providing landmark and stop information using the travel component.

17. The method of claim 16, wherein the travel component comprises a machine learning model that is trained on a dataset comprising:
travel itineraries;
geographic data;
landmark location information;
tourist destinations; and
activities at locations.

18. The method of claim 16, further comprising:
receiving, by the travel component, voice commands or text commands.

19. The method of claim 16, further comprising:
providing, by the travel component, audio guidance or text-based guidance.

20. The method of claim 16,, further comprising:
recording digital media using a recording device;
uploading recorded media to storage using the travel component;
compiling digital media, an itinerary, and trip information based on data stored by a storage device;
generating a trip reflection using the data of the storage device; and
displaying the trip reflection using a feedback component.
